(19) United States
(12) Patent Application Publication
(10) Pub. No.: US 2015/0193765 A1
(43) Pub. Date: Jul. 9, 2015

(54) Method and System for Mobile Payment and Access Control

(71) Applicant: Powa Technologies (Hong Kong) Limited, Hong Kong (HK)

(72) Inventor: Alessandro GADOTTI, Hong Kong (HK)

(21) Appl. No.: 14/659,634

(22) Filed: Mar. 17, 2015

Related U.S. Application Data
(63) Continuation-in-part of application No. 13/602,197, filed on Sep. 2, 2012.
(60) Provisional application No. 61/954,577, filed on Mar. 17, 2014.

(51) Int. Cl. G06Q 20/32

(52) U.S. Cl. CPC G06Q 20/3276; G06Q 20/3278

(57) ABSTRACT

A system and method for conducting payment transaction using a mobile device equipped with a NFC interrogator, comprising: creating a payer user account in a server and associating a payer mobile device with the payer user account; registering, by the server, a payee NFC identity tag; recording, by the server, a payment transaction and associating the payment transaction record to the payee NFC identity tag; interrogating the payee NFC identity tag by the payer mobile device; transmitting the acquired identifier of the payee NFC identity tag to the server; matching the received identifier to the associated payment transaction record; retrieving and sending to the payer mobile device the matched associated payment transaction information; displaying the payment transaction information in the payer mobile device for user confirmation; transmitting the confirmed information and the payer mobile device identification data to the server to complete the payment transaction.

### CLAIM FOR DOMESTIC PRIORITY

This application claims priority under 35 U.S.C. §119 to the U.S. Provisional Patent Application No. 61/954,577, filed Mar. 17, 2014, the disclosure of which is incorporated herein by reference in its entirety.

### CROSS-REFERENCES TO RELATED APPLICATIONS

This application is a continuation-in-part application of the U.S. patent application Ser. No. 13/602,197 filed Sep. 2, 2012, the disclosure of which is incorporated herein by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to methods of management and execution of electronic bill payments, electronic purchase payments, fund transfers, other value exchanges, and physical facility access control. More specifically, the present invention relates to methods of management and execution of financial transactions and access control using mobile communication devices and particularly devices incorporating barcode, Quick Response (QR) code, and near field communication (NFC) technologies.

### BACKGROUND

Modern day commerce involves conducting financial transactions through many different channels using a variety of instruments. Payment transfer of physical currency has been the most common means when the transacting parties are located away from any banking facility. Other payment methods and systems have appeared over the years. Credit cards, debit cards, Internet online payment services such as PayPal™, and monetary value holding electronic devices and systems, such as the near field communication (NFC) enabled Octopus Card widely used in Hong Kong, China, are some of the examples. However, none of the existing payment methods and systems has achieved the same level of ubiquity and ease of use as cash. Each of these payment methods and systems requires its dedicated infrastructure and/or is limited to a few channels. Another shortcoming of existing payment methods and systems is that person-to-person transactions are either unfeasible or highly inconvenient.

Due to their low production and distribution costs, the use of barcodes, QR codes, NFC and other radio-frequency identification (RFID) devices has gained tremendous popularity in various commercial and industrial applications. With the recent rise of use of “smartphones” incorporating cameras and NFC technologies and capable of running a wide variety of application software, many individuals are finding themselves equipped with ready and portable barcode and QR code scanners and NFC interrogators/readers. The present invention takes advantage of these increasingly prevalent smartphones equipped with cameras and NFC interrogators/readers in the hands of consumers in conducting various mobile payment transactions, ticketing management, and access control applications.

### SUMMARY

It is an objective of the presently claimed invention to provide a mobile payment and access control method and system utilizing mobile communication devices, barcode, and NFC technologies. It is a further objective of the presently claimed invention to provide such method and system that can leverage existing mobile communication devices and communication infrastructures, and does not require a dedicated infrastructure of hardware or network. It is still a further objective of the presently claimed invention to provide such method and system having a higher level of security than existing payment methods and systems.

In accordance with various embodiments, the presently claimed invention comprises a central processing server accessible through a first communication network, such as the Internet; a plurality of users including consumer users and provider users; mobile communication devices and client computing devices that can access the central processing server through the first communication network; and financial institutions, exchanges, and clearance centers connected to the central processing server through a second communication network, which can be the same as the first communication network.

In accordance with various embodiments, the functionalities of the central processing server comprises user account management for managing user accounts and authenticating users, wherein the user accounts contain user identification and banking information, and are stored securely in a data repository. The banking information includes information on one or more funding sources, such as credit cards, debit cards, and bank accounts; and fund receiving destinations. The central processing server provides the functionality of an electronic repository of credits or monetary units for each user account. The central processing server also provides transaction clearance functionality for processing payments and financial transactions for the users associated with the user accounts. The central processing server has backend network connections and machine-to-machine integration mechanisms, such as application program interfaces (APIs), to connect and interface with financial institutions, financial exchanges, and clearance centers, facilitating the processing of payments and financial transactions for and between the users associated with the user accounts.

In accordance with various embodiments, the central processing server includes a plurality of user interfaces for user interaction using various types of computing devices and mobile communication devices running web browser applications. In addition, the central processing server also includes secure mobile payment and access control server backend APIs for machine-to-machine integration enabling specially-developed applications running in computing devices or mobile communication devices to communicate with the central processing server. These user interfaces and secure mobile payment and access control server backend APIs facilitate the functionalities including, but are not limited to, user account management and online shopping by users, system administration by administrators, online shopping inventory, payment, and fulfillment management by users, events and access control management by users, NFC identity device/tag and barcode/QR code registration, linking, and management by users.

In accordance with various embodiments, each user account in the secure mobile payment and access control system may associate (pair) with only a single user's mobile communication device at any one time. The user may also be required to define a security personal identification number (PIN) for his/her user account.

In accordance with various embodiments, the user's mobile communication device is equipped with a NFC interrogator capable of generating interrogating radio communication signals, receiving response radio communication signals from and establishing data exchanges with NFC identity devices and tags. The NFC interrogator in the user's mobile communication device can be a dedicated hardware component or a software-hardware based emulator in the mobile communication device.

In accordance with various embodiments, the NFC technology employed is based on the ISO/IEC 18000-3, ISO/IEC 14443, ISO/IEC 18092, and other standards defined by the NFC Forum; the disclosures of which are incorporated herein by reference in their entirety.

In accordance with various embodiments, the user's mobile communication device is configured to interrogate a NFC identity device or tag placed within its proximity, process the data received from the NFC identity device or tag, and execute the secure mobile payment and access control process. In accordance with various embodiments, the mobile communication device configuration for processing the data received from the NFC identity device or tag and executing the secure mobile payment and access control process is accomplished by installing and executing application software and/or firmware specifically designed for the mobile communication device (secure mobile payment and access control mobile application) in the mobile communication device. Optionally, the operating system of the mobile communication device is modified and/or configured to accomplish portions or all of the aforementioned functionalities. Examples of NFC capable mobile communication devices include, but not limited to, the Google® Nexus™ 10, HTC® One™, Nokia® Lumia™, Samsung® Galaxy™, and Sony® Xperia™.

In accordance with various embodiments, the NFC identity device or tag is capable of transmitting a series of data communication signal of identity data unique to each NFC identity device or tag at least within the secure mobile payment and access control system if not globally. The NFC identity device or tag can represent a prepaid monetary value, a proof of fund transfer authorization, an event pass or ticket, an access authorization badge, an entitlement to a discount coupon, or an entitlement to a product/service. The NFC identity device or tag can be embedded in various portable articles including, but not limited to, a wristband, a sticker, a badge, and a carrying card.

In accordance with various embodiments, the user's mobile communication device is equipped with a camera or scanner for optically capturing the image of the computer-generated barcode. In accordance with various embodiments, the user's mobile communication device is configured to process the captured barcode image and initiate the mobile payment and access control process. In accordance with various embodiments, the mobile communication device configuration for processing the barcode and executing the mobile payment and access control process is accomplished by installing and executing application software and/or firmware specifically designed for the mobile communication device (hereinafter referred to as “secure mobile payment and access control mobile application”) in the mobile communication device. Optionally, the operating system of the mobile communication device is modified and/or configured to accomplish portions or all of the aforementioned functionalities.

In accordance with various embodiments, the computer-generated barcode is a matrix or two-dimensional barcode such as a Quick Response (QR) code. The barcode can be generated by the central processing server, a mobile communication device running the secure mobile payment and access control mobile application, or a third party system. The barcode contains at least an identity data, which is unique to each barcode at least within the secure mobile payment and access control system if not globally. The barcode can represent a prepaid monetary value, a proof of fund transfer authorization, an event pass or ticket, an access authorization code, an entitlement to a discount coupon, or an entitlement to a product/service. The barcode can be printed and displayed on various portable articles including, but not limited to, a wristband, a sticker, a badge, and a carrying card.

In accordance to one embodiment, the mobile payment and access control method comprises obtaining a NFC identity device or tag or a barcode, registering and linking the NFC identity device or tag or the barcode to a user account of the mobile payment and access control system; specifying the information of a payment funding source and monetary value associated with the NFC identity device or tag or the barcode; and using the NFC identity device or tag or the barcode to make payments for purchases from merchants using the mobile payment and access control system by presenting the NFC identity device or tag to be interrogated by the merchants' NFC interrogators, or the barcode to be image-captured by the merchants' scanner/camera; wherein the payments for purchases are settled by deducting from the previously specified payment funding source.

In accordance to another embodiment, the mobile payment and access control method comprises obtaining a NFC identity device or tag or a barcode; associating the NFC identity device or tag or the barcode to an event access authorization, a facility access authorization, or an entitlement to a product/service; linking the NFC identity device or tag or the barcode with a consumer's user account by using the consumer's mobile communication device that has been paired with the consumer's user account to interrogate the NFC identity device or tag, or image-capture the barcode; and using the NFC identity device or tag or the barcode to gain access to the event, facility, or to obtain the product/service by the consumer presenting the NFC identity device or tag to be interrogated by a NFC interrogator, or the barcode to be image-captured by a scanner/camera operated by the provider. After the NFC identity device or tag or the barcode is used, the central processing server de-link the NFC identity device or tag or the barcode from the consumer's user account and communicates with the consumer's mobile communication device to notify the consumer of the de-linking.

In accordance to yet another embodiment, the mobile payment and access control method comprises obtaining a NFC identity device or tag or a barcode; associating the NFC identity device or tag or the barcode to an entitlement to a discount coupon; receiving the discount coupon by interrogating the NFC identity device or tag, or image-capturing the barcode using the consumer's mobile communication device that has been paired with consumer's user account in the mobile payment and access control system; associating the received discount coupon with the consumer's user account; and applying the received discount coupon in a payment transaction.

### BRIEF DESCRIPTION OF THE DRAWINGS

Embodiments of the invention are described in more detail hereinafter with reference to the drawings, in which

FIG. 1 shows a block diagram illustrating an exemplary embodiment of the presently claimed secure mobile payment and access control system;

FIG. 2A and FIG. 2B depict a use case diagram illustrating an embodiment of a process of making a purchase payment in accordance to the presently claimed invention;

FIG. 3A and FIG. 3B depict a use case diagram illustrating an embodiment of a process of generating an event ticket and attending an event in accordance to the presently claimed invention; and

FIG. 4A and FIG. 4B depict two use case diagrams illustrating two embodiments of a process of generating a discount coupon, receiving, and applying the discount coupon in a payment transaction in accordance to the presently claimed invention.

### DETAILED DESCRIPTION

In the following description, methods and systems of secure mobile payment and access control and the like are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

System:

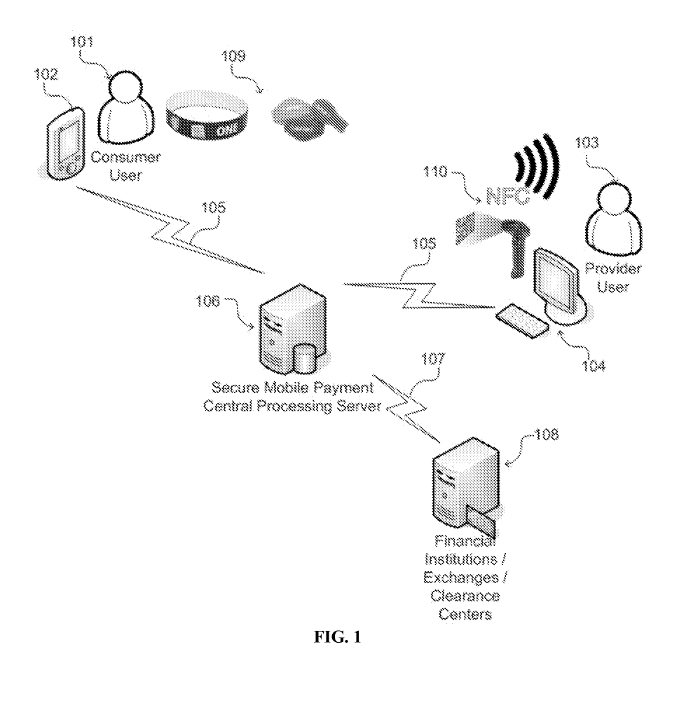

Referring to FIG. 1. In accordance with various embodiments the presently claimed invention comprises a central processing server 106 accessible through a first communication network 105, which can be the Internet, a telecommunication network, or any network supporting the TCP/IP protocol; a plurality of users including consumer users 101, and provider users 103, each associating with a user account; mobile communication devices 102; optionally point of sale (POS) terminals/counters/kiosks 104 that can access the central processing server through the first communication network 105; near field communication (NFC) identity (ID) tags and articles printed with barcodes (or QR codes) 109; NFC interrogators and barcode (or QR code) scanners/cameras 110 connected to the POS terminals/counters/kiosks 104 that can access the central processing server 106; financial institutions, exchanges and clearance centers 108 connected to the central processing server 106 through a second communication network 107, which can be the same as the first communication network 105 or a separate communication network.

In accordance with various embodiments, the functionalities of the central processing server 106 comprises user account management for managing user accounts and authenticating users, wherein a data record of a user account comprises the user's identification and banking information. The banking information includes information on one or more funding sources, such as credit cards, debit cards, and bank accounts; and fund receiving destinations. The central processing server 106 provides the functionality of an electronic repository of credits or monetary units for each user account. The central processing server 106 also provides transaction clearance functionality for processing payments and financial transactions for the users associated with the user accounts. The central processing server 106 has backend network connections and machine-to-machine integration mechanisms, such as APIs, to connect and interface with the financial institutions, financial exchanges, and clearance centers 108, facilitating the processing of payments and financial transactions for and between the users 101 associated with the user accounts.

In accordance with various embodiments, the central processing server 106 includes a first group of user interfaces for consumer users accessible by the mobile communication devices 102 and other computing devices through the first communication network 105; and a second group of user interfaces for provider users accessible by the mobile communication devices 102, other computing devices, and the POS terminals/counters/kiosks 104 through the first communication network 105. Both groups of user interfaces include interactive transactional web sites that can be displayed in web browser applications running in the mobile communication devices 102 and other computing devices, and user interfaces that are specifically designed for specifically-developed software applications running in the mobile communication devices 102 and other computing devices. One exemplary embodiment of such user interface is a mobile application (App) running on the iOS operating system developed by Apple Inc. Another exemplary embodiment of such user interface is a mobile application (App) running on the Android operating system developed by Google Inc. The central processing server also provides a third group of user interfaces for system administrative users accessible by the mobile communication devices 102 and other computing devices through the first communication network 105.

In addition to the groups of user interfaces, the central processing server 106 also includes secure mobile payment server backend APIs for machine-to-machine integration, enabling specifically-developed software applications running in mobile communication devices or other computing devices to communicate with the central processing server 106. In accordance to various embodiments, the machine-to-machine data interchanges via the secure mobile payment server backend APIs supports industry standards including, but are limited to, XML and JSON.

These user interfaces and secure mobile payment and access control server backend APIs facilitate the functionalities including, but are not limited to, user account management and online shopping by users, system administration by administrators, online shopping inventory, payment, and fulfillment management by users, events and access control management by users, NFC identity device/tag and barcode/QR code registration, linking, and management by users.

In accordance with various embodiments, the central processing server 106 includes a data repository for preserving data records of the user accounts, information on the financial institutions, financial exchanges, and clearance centers 108, system configuration data, and other meta data. The data repository can be implemented in the same physical computer server of the central processing server 106, or in a separate physical computer server. Exemplary embodiments of the data repository are various commercially available relational database management systems such as Oracle® Database and Microsoft® SQL Server.

In accordance with various embodiments, each user account in the secure mobile payment and access control system may associate (pair) with only a single user's mobile communication device at any one time. Each of the users 101 may also be required to define a security personal identification number (PIN) for his/her user account according to the system configuration.

In accordance with various embodiments, each of the mobile communication devices 102 is equipped with a NFC interrogator capable of generating interrogating radio communication signals, receiving response radio communication signals from and establishing data exchanges with NFC identity devices and tags 109. The NFC interrogator can be a dedicated hardware component or a software-hardware based emulator in the mobile communication device.

In accordance with various embodiments, the NFC technology employed is based on the ISO/IEC 18000-3, ISO/IEC 14443, ISO/IEC 18092, and other standards defined by the NFC Forum; the disclosures of which are incorporated herein by reference in their entirety.

In accordance with various embodiments, each of the mobile communication device 102 is configured to interrogate any of the NFC identity devices and tags 109 placed within its proximity, process the data received from the NFC identity device or tag, and execute the secure mobile payment and access control process. In accordance with various embodiments, the mobile communication device configuration for processing the data received from the NFC identity device or tag and executing the secure mobile payment and access control process is accomplished by installing and executing application software and/or firmware specifically designed for the mobile communication device (secure mobile payment and access control mobile application) in the mobile communication device. Optionally, the operating system of the mobile communication device is modified and/or configured to accomplish portions or all of the aforementioned functionalities. Examples of NFC capable mobile communication devices include, but not limited to, the Google Nexus™ 10, HTC One™, Nokia Lumia™, Samsung Galaxy™, and Sony Xperia™.

In accordance with various embodiments, each of the NFC identity devices and tags 109 is capable of transmitting a series of data communication signal of identity data unique to each NFC identity device or tag at least within the secure mobile payment and access control system if not globally. The NFC identity device or tag can represent a prepaid monetary value, a proof of fund transfer authorization, an event pass or ticket, an access authorization badge, an entitlement to a discount coupon, or an entitlement to a product/service. The NFC identity device or tag can be embedded in various portable articles including, but not limited to, a wristband, a sticker, a badge, and a carrying card.

In accordance with various embodiments, each of the mobile communication devices 102 is equipped with a camera or scanner for optically capturing images of computer-generated barcodes. In accordance with various embodiments, the mobile communication device is configured to process the captured barcode image and initiate the mobile payment and access control process. In accordance with various embodiments, the mobile communication device configuration for processing the barcode and executing the mobile payment and access control process is accomplished by installing and executing application software and/or firmware specifically designed for the mobile communication device (hereinafter referred to as “secure mobile payment and access control mobile application”) in the mobile communication device. Optionally, the operating system of the mobile communication device is modified and/or configured to accomplish portions or all of the aforementioned functionalities.

In accordance with various embodiments, the computer-generated barcode is a matrix or two-dimensional barcode such as a Quick Response (QR) code. The barcode can be generated by the central processing server 106, the mobile communication devices 102 running the secure mobile payment and access control mobile application, or a third party system. The barcode contains at least an identity data, which is unique to each barcode at least within the secure mobile payment and access control system if not globally. The barcode can represent a prepaid monetary value, a proof of fund transfer authorization, an event pass or ticket, an access authorization code, an entitlement to a discount coupon, or an entitlement to a product/service. The barcode can be printed and displayed on various portable articles including, but not limited to, a wristband, a sticker, a badge, and a carrying card.

Consumer User Account Setup:

In accordance to various embodiments, a consumer user in the secure mobile payment and access control system can act as a payer or a payee at any point of time depending on the transaction being conducted. In general, a consumer user uses an NFC identity device or tag or the barcode to pay for purchases, pay for and access events, receive discounts and products/services. The method of secure mobile payment and access control comprises a consumer user account setup process, wherein the consumer user account setup process comprises the steps of user registration, user validation, user profile management, funding source and fund-receiving destination management, and device pairing as listed below:

User Registration:

1. A new consumer user accesses the central processing server user interface using a client computing device with a browser software application or a mobile communication device configured to access the central processing server user interface.
2. The new consumer user selects create user account action in the central processing server user interface, provides his/her personal information including at least his/her first name, last name, and email address, a mobile phone number including the country code, and provides a password for subsequently signing into the central processing server.
3. The new consumer user is also asked to select from a list of security questions, such as “Where did you travel on your honeymoon?” and “What is the name of your first pet?”, and provide the answer to the chosen security question. Lastly, the new consumer user is asked to provide the answer to a qualifying question, such as a portion of a government issued identification number.

User Validation:

4. The central processing server sends a validation email to the email address provided by the new consumer user.
5. The newly created user account is validated by the new consumer user receiving and reading the validation email, and accessing a validation web hyperlink, which bears the new consumer user's personal identification data within, in the validation email.
6. The access action of the validation web hyperlink sends the new consumer user's personal identification data to the central processing server; and upon the receipt of this data, the validation of the newly created user account is completed, and the new consumer user is notified as such.

User Profile Management:

7. After the newly created user account is validated, the new consumer user can access his/her user account by accessing the central processing server user interface and signing in using his/her email address, mobile phone number, and password.
8. After signing into his/her user account, the new consumer user can enter and modify his/her user profile information including, but is not limited to, name, email address, residence address, business address, delivery address, and mobile phone number for being saved and associated with his/her user account.

Funding Source and Fund-Receiving Destination Management:

9. Within the user account signed-in session, the new consumer user can add, modify, and remove one or more funding source and fund-receiving destination associating with his/her user account. A funding source and a fund-receiving destination are for crediting to (recharging) and debiting from (withdrawing) respectively the virtual repository of monetary units of his/her user account. Direct crediting to and direct debiting from a funding source and a fund-receiving destination respectively in a transaction is also possible. For adding a funding source or a fund-receiving destination, the new consumer user can select a credit card, debit card, bank account, or other funding source type, enter the card number or account number, the card or account holder's name and billing address, applicable expiration date and verification code.
10. The central processing server creates an unverified funding source or fund-receiving destination with the information entered by the new consumer user.
11. Only a verified funding source or a fund-receiving destination can be used to recharge or withdraw the virtual repository of monetary units of the user account, or for direct crediting to or direct debiting from a transaction. The new consumer user can initiate the verification of the newly added funding source or fund-receiving destination within the user account signed-in session.
12. For credit card type funding source, a debit of small amount is made against the credit card with a reference identifier associated with the transaction, which is shown on the credit card account statement. The debited amount is credited to the virtual repository of monetary units of the new consumer user's user account. The funding source verification is completed upon the new consumer user retrieving the reference identifier and entering it in the central processing server user interface during a user account signed-in session.
13. For bank account type funding source and fund-receiving destination, two debits of two different amounts are made against the bank accounts, which can be shown on the bank account statement. The debited amounts are credited to the virtual repository of monetary units of the new consumer user's user account. The funding source verification is completed upon the new consumer user being notified of the two debits and entering them central processing server user interface during a user account signed-in session.
14. Within the user account signed-in session, the new consumer user can indicate to the central processing server to link the virtual repository of monetary units of her/her user account with one or more verified funding sources and/or verified fund-receiving destinations for transferring funds between the virtual repository of monetary units and the linked verified funding sources and/or verified fund-receiving destinations.

Device Pairing:

15. A mobile communication device equipped with a NFC interrogator and/or a camera or barcode scanner must be associated (paired) with the new consumer user's user account. Only one mobile communication device can be paired with a user account at any one time. If a user account is already paired with a mobile communication device, it must be unpaired before another mobile communication device is paired with the user account.
16. The new consumer user configures his/her mobile communication device to be able to access the central processing server user interface. In one exemplary embodiment, the new consumer user uses his/her mobile communication device to access a mobile application store, find, download, and install the secure mobile payment and access control mobile application, which is specifically designed to interact with the central processing server, in his/her mobile communication device. By launching and interacting with the secure mobile payment and access control mobile application running in his/her mobile communication device, the new consumer user can access the central processing server to initiate the pairing process.
17. Using the secure mobile payment and access control mobile application running in his/her mobile communication device, the new consumer user signs in to his/her user account using his/her email, mobile phone number, and password that are registered in a prior user registration. The user authentication information is sent to the central processing server for authentication along with the mobile communication device's identification data.
18. The central processing server authenticates the new consumer user. Upon a positive authentication, the central process server identifies that the mobile communication device is not yet paired with the user account, replies with the previously chosen security question and qualifying question to the mobile communication device running the secure mobile payment and access control mobile application.
19. The new consumer user is prompted to enter an answer to the security question and an answer to the qualifying question; and the answers are sent to the central processing server.
20. The central processing server verifies the security answer and the qualifying answer. Upon a positive verification, the central processing server sends the mobile communication device a SMS message communication containing an activation code.
21. Upon receiving the SMS message communication and the activation code contained within, the new consumer user enters the activation code and a user-defined security PIN in the secure mobile payment and access control mobile application. In one embodiment, the security PIN can be a 4, 5, or 6-digit number combination.
22. The secure mobile payment and access control mobile application performs a cryptographic hash operation on the security PIN received. The activation code and the cryptographic hash of the security PIN are sent to the central processing server for verification and storage, completing the device pairing process.

Provider User Account Setup:

In accordance to various embodiments, a provider user in the secure mobile payment and access control system can act as a payer or a payee at any point of time depending on the transaction being conducted. In general, a provider user accepts the use of the NFC identity device or tag or the barcode to pay for purchases, pay for and access events, and distributes entitlements to products/services and discount coupons. The method of secure mobile payment and access control comprises a provider user account setup process, wherein the provider user account setup process comprises the steps of user registration, user validation, user profile management, funding source and fund-receiving destination management, device pairing, and user account activation as in the consumer user account setup process as described above. The provider user account setup process, however, further comprises the steps of creating delegate users, delegate user validation, and delegate user device pairing.

Creating Delegate Users:

1. After the user validation step is complete, the new provider user can access his/her user account by accessing the central processing server user interface and signing in using his/her email address, mobile phone number, and password. Using the central processing server user interface, the new provider user provides the identity information, email addresses, mobile phone numbers, and passwords of one or more delegate users. The new provider user can specify the level of authorization and access for each delegate user; wherein the level of authorization is selected from a selection comprising: view the provider user's user account information only, administer the provider user's user account, make payments, request payments from others, create and manage events, create and management entitlements to products/services, and create and manage discount coupons. The new provider user can specify limits on attributes in each of the level of authorization such as spending amounts for each delegate user at the make payments level.

Delegate User Validation:

2. After the new provider user created the one or more delegate users, the central processing server sends a validation email to each of the delegate user email addresses provided by the new provider user. The remaining delegate user validation steps are substantially the same as the user validation steps for consumer user.

Delegate User Device Pairing:

3. If a delegate user is assigned a level of authorization of making payments or requesting payments from others or above, the delegate user can pair his/her mobile communication device with the provider user's user account. The delegate user device pairing steps are substantially the same as device pairing steps for consumer user.

Consumer User Registering and Linking a NFC Identity Device or Tag or Barcode Wallet:

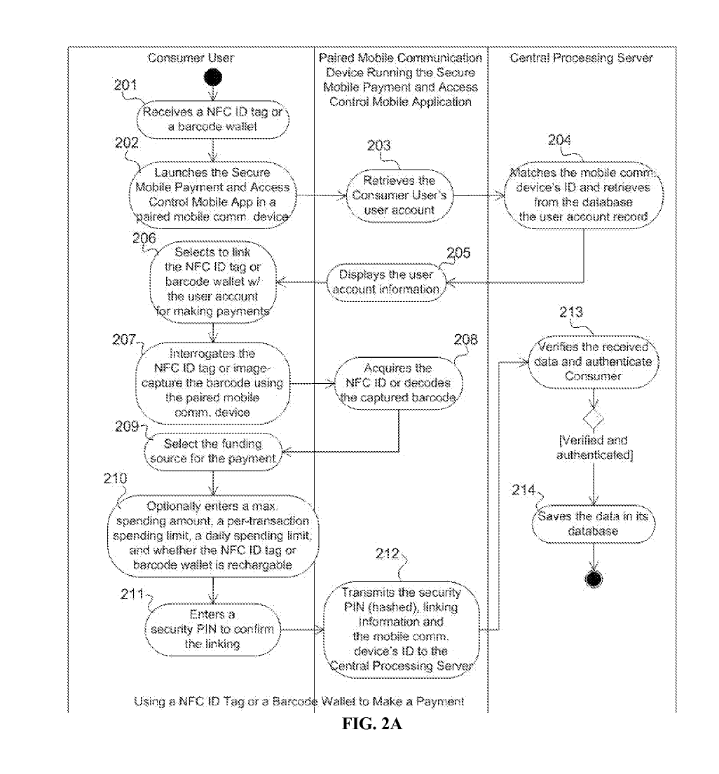

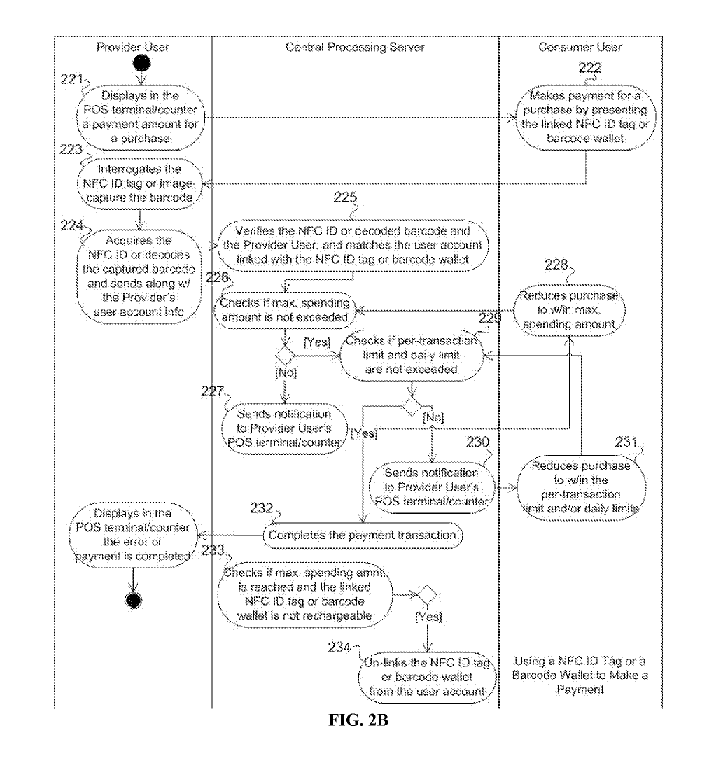

Referring to FIG. 2A. In accordance to various embodiments, the method of secure mobile payment and access control comprises a process of registering and linking a NFC identity device or tag or barcode wallet to the consumer user's user account and a process of paying for purchases using the linked NFC identity device or tag or barcode comprising the following steps:

1. (201) The consumer user obtains a NFC identity device or tag or barcode wallet, which is generally a portable article, such as a wristband, embedded with the NFC identity tag and/or imprinted with the barcode, wherein the NFC identity device or tag or barcode wallet can be obtained from a provider user. In the case of a barcode, the consumer user could also generate the barcode by accessing the central processing server via its user interfaces and print the barcode generated on to a physical media.
2. (202) The consumer user launches the secure mobile payment and access control mobile application in his/her mobile communication device if it is not already running; wherein the mobile communication device has already been paired with the consumer user's user account.
3. (203) The mobile communication device running the secure mobile payment and access control mobile application communicates with the central process server to retrieve the consumer user's user account information; wherein the communication involves at least the mobile communication device sending its identification data to the central processing server.
4. (204) The central processing server uses the mobile communication device's identification data to find and match the consumer user's user account record, retrieves from the data repository the matched user account record and sends it back to the mobile communication device.
5. (205) The mobile communication device running the secure mobile payment and access control mobile application displays on its screen the consumer user's user account information.
6. (206) Through the secure mobile payment and access control mobile application user interface, the consumer user commands to link the NFC identity device or tag or barcode wallet to his/her user account.
7. (207) The consumer user uses his/her mobile communication device to interrogate the NFC identity device or tag; or image-capture the barcode.
8. (208) The mobile communication device running the secure mobile payment and access control mobile application interrogates and acquires the NFC ID of the NFC identity device or tag; or decodes the image-captured barcode.
9. (209) The consumer user selects the funding source using the secure mobile payment and access control mobile application user interface.
10. (210) The consumer user can optionally enters additional NFC identity device or tag or barcode wallet information including, but not limited to, a maximum spending amount, a per-transaction spending limit, a daily spending limit, and whether the NFC identity device or tag or barcode wallet is rechargeable using the secure mobile payment and access control mobile application user interface.
11. (211) The consumer user enters his/her security PIN in the secure mobile payment and access control mobile application user interface to be cryptographically hashed by the secure mobile payment and access control mobile application.
12. (212) The mobile communication device running the secure mobile payment and access control mobile application sends the NFC identity device or tag or barcode wallet information, which includes the NFC ID or the decoded barcode data, the cryptographically hash of the consumer user's security PIN, and the mobile communication device's identity data to the central processing server.
13. (213) The central processing server authenticates the consumer user using the cryptographically hash of security PIN and the mobile communication device's identity data received, and processes the NFC identity device or tag or barcode wallet information.
14. (214) Upon positive authentication, the NFC identity device or tag or barcode wallet information is preserved in the data repository with meta data set and stored for referencing the NFC identity device or tag or barcode wallet information record to the consumer user's user account record. At this point, the NFC identity device or tag or barcode wallet is considered registered and linked with the consumer user's user account.

Consumer User Making Payments Using a NFC Identity Device or Tag or Barcode Wallet:

Referring to FIG. 2B. The process of paying for purchases using the linked NFC identity device or tag or barcode wallet comprising the following steps:

15. (221) At a provider user (including the provider user him/herself and his/her delegates)'s POS terminals/counters/kiosks, mobile communication device or computing device for generating and presenting bills of payment, a payment amount for a purchase is presented to the consumer user.
16. (222) The consumer user presents his/her linked NFC identity device or tag or barcode wallet for settling the purchase payment.
17. (223) Interrogates the NFC identity device or tag using the NFC interrogator connected to the provider user's POS terminals/counters/kiosks, mobile communication device or computing device, or image-captures the barcode using the barcode camera/scanner connected to the provider user's POS terminals/counters/kiosks.
18. (224) The provider user's POS terminal/counter/kiosk, mobile communication device or computing device acquires the NFC ID or decodes the image-captured barcode; and sends the NFC ID or the decoded barcode data to the central processing server along with at least the provider user's user account information.
19. (225) The central processing server receives the NFC ID or the decoded barcode data and the provider user's user account information; authenticates the provider user based on the received user account information; and finds and matches the received NFC ID or the decoded barcode data with user account records to determine the linked user account.
20. (226) The central processing server retrieves the linked user account record; the central processing server checks if a maximum spending amount has been set for the linked NFC identity device or tag or barcode wallet, then verifies that the purchase payment will not exceed the remaining balance towards the maximum spending amount.
21. (227) If the condition in step 20 is met, continues the process, otherwise, the central processing server sends a notification message to the provider user's POS terminals/counters/kiosks to notify the provider user and the consumer user of insufficient funds.
22. (228) The consumer user can opt to reduce his/her purchases to cost within than the remaining balance towards the maximum spending amount; if the consumer user does so, then resume the payment transaction from step 20.
23. (229) The central processing server checks if a per-transaction spending limit has been set for the NFC identity device or tag or barcode wallet and if so, verifies if the purchase payment exceeds the per-transaction spending limit; the central processing server checks if a daily spending limit has been set for the NFC identity device or tag or barcode wallet and if so, verifies that the purchase payment will not exceed the day's remaining balance towards the daily spending limit.
24. (230) If either condition in step 23 is violated, the central processing server sends a notification message to the provider user's POS terminals/counters/kiosks indicating the per-transaction spending limit or daily spending limit that is being exceeded.
25. (231) The consumer user can opt to break up his/her purchases into multiple transactions or reduce his/her purchases to cost within than the remaining balance towards the per-transaction spending limit or daily spending limit; if the consumer user does so, then resume the payment transaction from step 23.
26. (232) The central processing server executes the payment transaction transferring funds for the purchase payment from the consumer user's funding source or virtual repository of monetary units to the provider user's fund-receiving destination or virtual repository of monetary units according to their respective user account setup.
27. The central processing server then sends the execution result of the payment transaction to both the consumer user and the provider user by electronic mail, Internet instant message, SMS telecommunication message, communication message for the secure mobile payment and access control mobile application, or communication via the secure mobile payment and access control server backend APIs. The transaction execution results and history logs are also shown in a web site accessible and readable by a computing device or a mobile communication device running a web browser application, or any application software or firmware designed specifically to access and display web contents.
28. The provider user's POS terminal/counter/kiosk receives the communication message containing the transaction execution result and displays the transaction execution result to the consumer user.
29. (233) The central processing server determines from the consumer user's user account record whether the linked NFC identity device or tag or barcode wallet is rechargeable; and if not rechargeable, then checks if the linked NFC identity device or tag or barcode wallet's maximum spending amount has been reached by the payment transaction just executed.
31. (234) If the condition in step 30 is met, the central process server sets/clears the meta data in the consumer user's user account record to de-link the NFC identity device or tag or barcode wallet or deletes the record of the NFC identity device or tag or barcode wallet, terminating its further use.

Provider User Creating an Event and Registering and Linking a NFC Identity Device or Tag or Barcode:

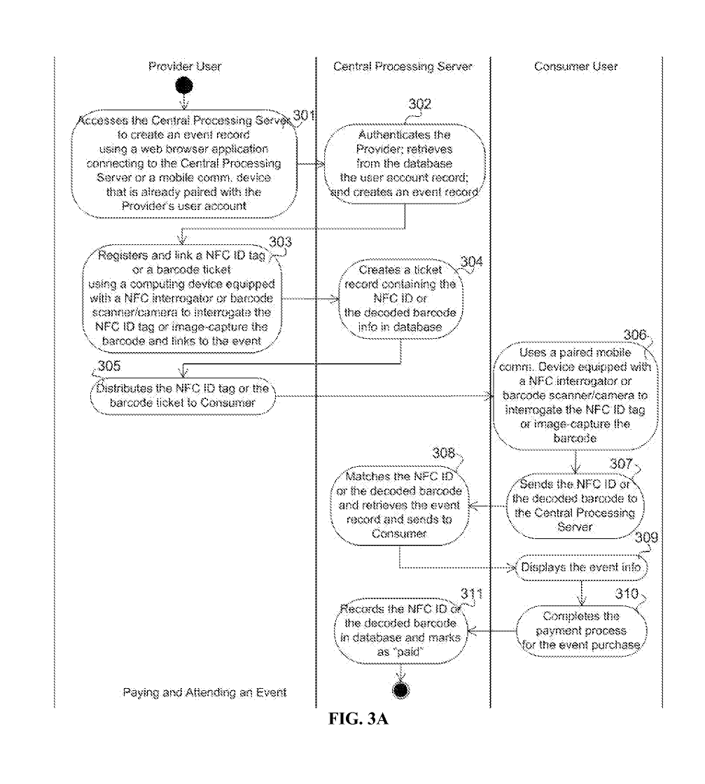

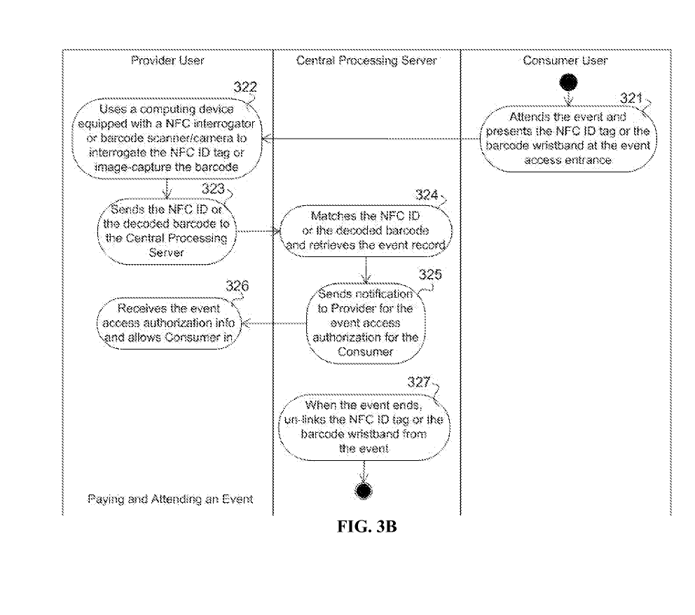

Referring to FIG. 3A. In accordance to one embodiment, the method of secure mobile payment and access control comprises a process of a provider user generating one or more NFC identity devices and/or tags and/or barcodes as event tickets comprising the following steps:

1. (301) A provider user (including the provider user him/herself and his/her delegates) uses a web browser application or a web accessing application running in a computing device or mobile communication device, or the secure mobile payment and access control mobile application running in his/her paired mobile communication device to access the user interface of the central processing server to create a record of new upcoming event in connection with the provider user's user account, wherein the record of the new upcoming event may include, but not limited to, the event's identifier, name, description, start time(s) and date(s), end time(s) and date(s), venue(s), ticket categories, ticket price per category, maximum number of tickets per category.
2. (302) During the central processing server access, the provider user is challenged for and provides his/her login credentials. The central processing server authenticates the provider user using his/her login credentials provided against the saved credential data in the matched user account record. Upon the successful provider user authentication and completion of specifying new upcoming event information, the new upcoming event record is created and saved in the data repository
3. (303) The provider user uses a NFC interrogator, camera or barcode scanner that is connected to the computing device or mobile communication device to interrogate a new NFC identity device or tag, or image-capture a new barcode. The computing device or mobile communication device acquires the NFC ID of the NFC identity device or tag, or decodes the barcode and sends the NFC ID or decoded barcode data to the central processing server. Through the user interface of the central processing server, the provider user commands the central processing server to link the acquired NFC ID or the decoded barcode data to the record of the new upcoming event as a ticket and create a new ticket record. Through the user interface of the central processing server, the provider user can optionally specify and/or select additional ticket information including, but not limited to, the ticket category, ticket price, event start time and date, event end time and date, event venue, seat number, and “paid/unpaid” status for the newly created ticket record. In an alternative embodiment, if a printer is accessible to the provider user, a pre-linked barcode can be generated by and printed by commanding through the user interface of the central processing server.
4. (304) The central processing server creates the new ticket record for the acquired NFC ID or the decoded barcode data along with the additional ticket information and links to the event record.

Consumer User Paying for the Linked NFC Identity Device or Tag or Barcode Event Ticket:

Still referring to FIG. 3A. In accordance to one embodiment, the method of secure mobile payment and access control comprises a process of a consumer user receiving a linked NFC identity device or tag or barcode event ticket and making payment for the event ticket comprising the following steps:

5. (305) The provider user distributes the linked NFC identity device or tag or barcode event ticket to an event attendee or ticket purchaser. If the linked NFC identity device or tag or barcode event ticket has a “paid” status, the linked NFC identity device or tag or barcode event ticket can be given out as a pre-paid ticket or a ticket to be purchased off-line (payment made not using the secure mobile payment and access control system).
6. (306) The ticket purchaser who received the linked NFC identity device or tag or barcode event ticket having an “unpaid” status initiates the payment process. A ticket purchaser who is not yet a registered user in the secure mobile payment and access control system must first complete his/her User Registration process as described above. Acting as a consumer user, the ticket purchaser uses his/her paired mobile communication device running the secure mobile payment and access control mobile application to interrogate the linked NFC identity device or tag, or image-capture the barcode.
7. (307) The consumer user's mobile communication device acquires the NFC ID of the linked NFC identity device or tag, or decodes the linked barcode; and sends the NFC ID or decoded barcode data to the central processing server.
8. (308) The central processing server finds and matches the received NFC ID or decoded barcode data with the ticket records; retrieves the matched ticket record and the linked event record data; and sends the data to the consumer user's mobile communication device.
9. (309) The consumer user's mobile communication device running the secure mobile payment and access control mobile application displays the ticket record and the linked event record data to the consumer user.
10. (310) The consumer user's mobile communication device running the secure mobile payment and access control mobile application then prompts the consumer user to purchase the ticket and enter his/her security PIN to complete the payment process. With the security PIN entered, the customer user indicates in the secure mobile payment and access control mobile application to complete the payment transaction.
11. (311) The secure mobile payment mobile application performs a cryptographic hash operation on the security PIN received and transmits the cryptographic hash of the security PIN to the central processing server along with the verified payment transaction information, and identification data of the mobile communication device. The central processing server receives the information and verifies the authenticity of the information received and the customer user using the customer user supplied security PIN, the identification data of the mobile communication device, and data in customer user account preserved in the data repository. If the authenticity of the information received and the customer user's identity are positively verified, the central processing server executes the payment transaction by transferring funds for the ticket purchase from the consumer user's funding source or virtual repository of monetary units to the provider user's fund-receiving destination or virtual repository of monetary units according to their respective user account setup. The central processing server then set the status of the linked NFC identity device or tag or barcode event ticket to “paid” status by setting the corresponding data in the ticket record.

Consumer User Using a NFC Identity Device or Tag or Barcode Event Ticket to Attend the Event:

Referring to FIG. 3B. In accordance to one embodiment, the method of secure mobile payment and access control comprises a process of a consumer user using a “paid” NFC identity device or tag or barcode event ticket to attend an event comprising the following steps:

12. (321) The consumer user attends the event and presents a NFC identity device or tag or barcode event ticket at the event entrance.
13. (322) The provider user uses a NFC interrogator or barcode scanner/camera connected to a computing device or mobile communication device to interrogate the linked NFC identity device or tag to image-capture the barcode. The computing device or mobile communication could be running a web browser application or a web accessing application, or could be already paired with the secure mobile payment and access control system and running the secure mobile payment and access control mobile application, to access the user interface of the central processing server.
14. (323) The provider user's computing device or mobile communication device acquires the NFC ID of the NFC identity device or tag, or decodes the barcode; and sends the NFC ID or decoded barcode data, along with present event information, including at least the present event identifier, and optionally present ticket category, present event start time and date, present event venue, and present seat number, to the central processing server.
15. (324) The central processing server matches the received NFC ID or decoded barcode data and the present event information with the ticket record and the linked event record; and verifies that the NFC identity device or tag or barcode event ticket is for the present event by matching the received present event identifier to the event identifier data in the linked event record, and optionally for the received present ticket category, present event start time and date, present event venue, and present seat number by matching the respective data in the ticket record.
16. (325) If the ticket record matched indicates that the NFC identity device or tag or barcode event ticket has a “paid” status, the central processing server generates an access authorization data message and sends, along with the ticket category, event start time and date, event end time and date event venue, and seat number, to the provider user's computing device or mobile communication device.
17. (326) The provider user's computing device or mobile communication device receives the access authorization data message. The provider user is notified of the access authorization and allows the consumer user into the event.
18. (327) If an event end time and date is specified in the ticket record of the NFC identity device or tag or barcode event ticket, the central processing server can be configured to automatically de-link the NFC identity device or tag or barcode event ticket from the event by either deleting the ticket record or setting/clearing the meta data in the ticket record that reference the ticket record to the event record. In an alternative embodiment, the provider user can uses a web browser application or a web accessing application running in a computing device or mobile communication device, or the secure mobile payment and access control mobile application running in his/her paired mobile communication device to access the user interface of the central processing server to de-link the NFC ID of the NFC identity device or tag event ticket.

Provider User Creating a NFC Identity Device or Tag or Barcode Coupon:

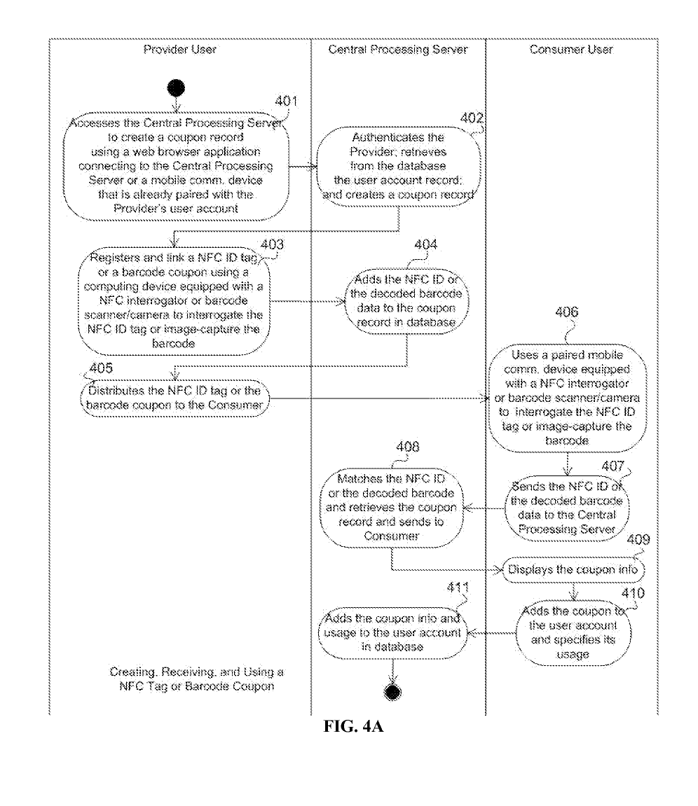

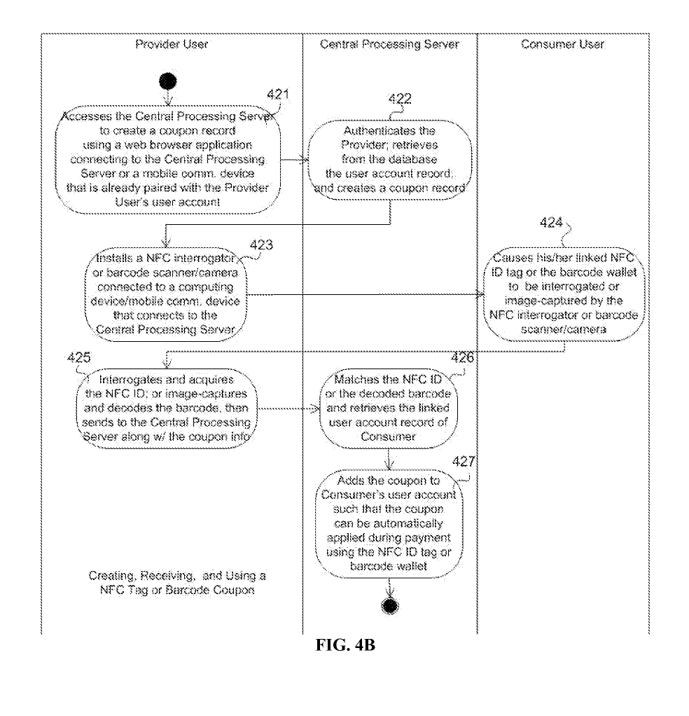

Referring to FIG. 4A. In accordance to one embodiment, the method of secure mobile payment and access control comprises a process of a provider user creating a NFC identity device or tag or barcode coupon, wherein the coupon can be used by a consumer user in making payments, comprising the following steps:

1. (401) A provider user (including the provider user him/herself and his/her delegates) uses a web browser application or a web accessing application running in a computing device or mobile communication device, or the secure mobile payment and access control mobile application running in his/her paired mobile communication device to access the user interface of the central processing server to create a record of a new coupon in connection with the provider user's user account, wherein the record of the new coupon may include, but not limited to, the coupon's identifier, name, description, start time and date, expiration time and date, applicable merchant(s), applicable locations/geographical areas, applicable purchase item(s), discount amount, and discount percentage.
2. (402) During the central processing server access, the provider user is challenged for and provides his/her login credentials. The central processing server authenticates the provider user using his/her login credentials provided against the saved credential data in the matched user account record. Upon the successful provider user authentication and completion of specifying new coupon information, the new coupon record is created and saved in the data repository.
3. (403) The provider user uses the NFC interrogator, barcode scanner or camera that is connected to the computing device or mobile communication device to interrogate a new NFC identity device or tag, or image-capture a new barcode. The computing device or mobile communication device acquires the NFC ID of the NFC identity device or tag, or decodes the barcode and sends the NFC ID or decoded barcode data to the central processing server. Through the user interface of the central processing server, the provider user commands the central processing server to add the acquired NFC ID or the decoded barcode data to the new coupon record.
4. (404) The central processing server adds the acquired NFC ID or the decoded barcode data to the coupon record.
5. (405) The provider user distributes the NFC identity device or tag or barcode coupon to the public by one or more methods including, but not limited to: direct email and/or other forms of electronic messaging such as Short Message Service (SMS) to one or more recipients or distribution lists; location-based (geo-fencing, the description of which can be found at http://en.wikipedia.org/wiki/Geo-fence) electronic messaging to computing devices and mobile communication devices located within certain geographical areas based on Global Positioning System (GPS) measurements, Internet addresses, wireless access point locations, cellular communication network receiver-transmitter location/triangulation, etc.; physical display at chosen locations; and distribution of physical portable articles such as magazines, flyers, wristbands, etc. embedded with the NFC identity device or tag or imprinted with the barcode.
6. (406) A consumer user receives or is shown the NFC identity device or tag or barcode coupon. The consumer user uses his/her paired mobile communication device that is equipped with a NFC interrogator and/or barcode scanner or camera to interrogate the NFC identity device or tag or image-capture the barcode. If the consumer user receives the coupon through direct email, other forms of electronic messaging, or geo-fencing distribution method, the coupon record data is retrieved from the central processing server by using the coupon identifier included in the direct email, the other form of electronic messaging, or the geo-fencing distribution received by the consumer user's mobile communication device and sent back to the central processing server. The central processing server then adds the coupon record data to the consumer user's user account record. In this case, the following steps 7-11 are skipped.
7. (407) The consumer user's mobile communication device, running the secure mobile payment and access control mobile application, acquires the NFC ID of the NFC identity device or tag, or decodes the barcode and sends the NFC ID or decoded barcode data to the central processing server.
8. (408) The central process server finds and matches the received NFC ID or decoded barcode data to the coupon record; retrieves the coupon record and sends the coupon record data back to the consumer user's mobile communication device.
9. (409) The consumer user's mobile communication device, running the secure mobile payment and access control mobile application, displays the coupon record data to the consumer user.
10. (410) By interacting with the secure mobile payment and access control mobile application running in the consumer user's mobile communication device, the consumer user commands to add the coupon to his/her user account and specifies its usage. The possible selections of usage include, but not limited to, applying all coupons automatically in all payment transactions, and applying individual coupon in a payment transaction by specific user's instruction. The consumer user's mobile communication device sends the coupon record data and usage selection data, and the consumer user's user account information to the central processing server.
11. (411) The central processing server adds the coupon record data and usage data to the consumer user's user account record.

Referring to FIG. 4B. In accordance to an alternative embodiment, the method of secure mobile payment and access control comprises an alternative process of a provider user creating a NFC identity device or tag or barcode coupon, wherein the coupon can be used by a consumer user in making payments, comprising the following steps:

1. (421) A provider user (including the provider user him/herself and his/her delegates) uses a web browser application or a web accessing application running in a computing device or mobile communication device, or the secure mobile payment and access control mobile application running in his/her paired mobile communication device to access the user interface of the central processing server to create a record of new coupon in connection with the provider user's user account, wherein the record of the new coupon may include, but not limited to, the coupon's identifier, name, description, start time and date, expiration time and date, applicable merchant(s), applicable locations/geographical areas, applicable purchase item(s), discount amount, and discount percentage.
2. (422) During the central processing server access, the provider user is challenged for and provides his/her login credentials. The central processing server authenticates the provider user using his/her login credentials provided against the saved credential data in the matched user account record. Upon the successful provider user authentication and completion of specifying new coupon information, the new coupon record is created and saved in the data repository.
3. (423) The provider user installs a NFC interrogator, barcode scanner or camera that is connected to a computing device or mobile communication device that connects to central processing server. The computing device or mobile communication device is capable of interacting with the secure mobile payment and access control server backend APIs provided by the central processing server.
4. (424) A consumer user causes his/her linked NFC identity device or tag or barcode wallet to be interrogated by the provider's NFC interrogator or image-captured by the provider's barcode scanner or camera.
5. (425) The provider user's computing device or mobile communication device acquires the NFC ID of the NFC identity device or tag, or decodes the barcode and sends the NFC ID or decoded barcode data along with the coupon identifier to the central processing server, and commands the central processing server to add the coupon to the consumer user's user account through the interaction with secure mobile payment and access control server backend APIs.
6. (426) The central processing server finds and retrieves the consumer user's user account record by matching the received NFC ID or decoded barcode data to the NFC identity device or tag or barcode wallet record and referencing the consumer user's user account record from the wallet record; and retrieves the coupon record by matching the received coupon identifier.
7. (427) The central processing server adds the coupon record data to the consumer user's user account record and sets the usage to automatically apply the coupon when payment transaction is made using the consumer's linked NFC identity device or tag or barcode wallet.

The embodiments disclosed herein may be implemented using general purpose or specialized computing devices, mobile communication devices, computer processors, or electronic circuitries including but not limited to digital signal processors (DSP), application specific integrated circuits (ASIC), field programmable gate arrays (FPGA), and other programmable logic devices configured or programmed according to the teachings of the present disclosure. Computer instructions or software codes running in the general purpose or specialized computing devices, mobile communication devices, computer processors, or programmable logic devices can readily be prepared by practitioners skilled in the software or electronic art based on the teachings of the present disclosure.

In some embodiments, the present invention includes computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Exemplary embodiments of mobile communication devices include, but are not limited to, mobile telephones, mobile telephones with personal computer like capability (commonly referred to as “smartphones”), electronic personal digital assistants (PDAs), portable computers with wired or wireless wide-area-network and/or telecommunication capability such as tablet personal computers and “netbook” personal computers.

Exemplary embodiments of POS terminals/counters include, but are not limited to, non-electronic cash registry machines, electronic cash registry machines, electronic kiosks, general purpose or specialized computing devices configured to execute POS software.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A computer implemented method for conducting a payment transaction using a near field communication (NFC) tag or barcode, comprising:
linking, by a first computer processor, a NFC tag or barcode to a consumer user account by saving the NFC tag identifier (ID) or barcode data in the first computer processor and referencing the NFC tag ID or barcode data to the consumer user account record maintained by the first computer processor, wherein the consumer user account record includes at least information of a funding source;
interrogating the NFC tag by a NFC interrogator connected to a second computer processor, or image-capturing the barcode by a barcode scanner or camera connected to the second computer processor;
acquiring the interrogated NFC tag ID, or extracting the image-captured barcode data by the second computer processor;
sending, by the second computer processor, the acquired NFC tag ID or extracted barcode data to the first computer processor;
finding and retrieving, by the first computer processor, the consumer user account record using the received NFC tag ID or barcode data; and
causing, by the first computer processor, to transfer monetary units from the funding source to settle the payment transaction.

2. The method of claim 1, wherein the barcode being Quick Response (QR) code.

3. The method of claim 1, further comprising:
determining, by the first computer processor, whether the payment transaction amount exceeds one or more spending limits;
wherein the consumer user account record further includes information of the one or more spending limits.

4. The method of claim 1, wherein the second computer processor being a processor in a mobile communication device, and wherein the mobile communication device being equipped with the NFC interrogator, or the barcode scanner or camera.

5. A computer implemented method for conducting event ticketing management using a near field communication (NFC) tag or barcode, comprising:
linking, by a first computer processor, a NFC tag or barcode to an event by saving the NFC tag identifier (ID) or barcode data in the first computer processor and referencing the NFC tag ID or barcode data to the event record maintained by the first computer processor;
interrogating the NFC tag by a NFC interrogator connected to a second computer processor, or image-capture the barcode by a barcode scanner or camera connected to the second computer processor;
acquiring the interrogated NFC tag ID or extracting the image-captured barcode data by the second computer processor;
sending, by the second computer processor, the acquired NFC tag ID or extracted barcode data to the first computer processor;
finding and retrieving, by the first computer processor, the event record using the received NFC tag ID or barcode data;
determining, by the first computer processor, whether the received NFC tag ID or barcode data represents a valid access to the event; and
if the received NFC tag ID or barcode data represents a valid access to the event, sending, by the first computer processor, to the second computer processor, a data message indicating authorization to access the event.

6. The method of claim 5, wherein the barcode being Quick Response (QR) code.

7. The method of claim 5, further comprising:
de-linking, by a first computer processor, the NFC tag or barcode from the event by removing the reference of the NFC tag ID or barcode data to the event record after the event ends.

8. The method of claim 5, wherein the second computer processor being a processor in a mobile communication device, and wherein the mobile communication device being equipped with the NFC interrogator, or the barcode scanner or camera.

9. A computer implemented method for conducting discount coupon management using a near field communication (NFC) tag or barcode, comprising:
linking, by a first computer processor, a NFC tag or barcode to a discount coupon by adding the NFC tag identifier (ID) or barcode data to the discount coupon record maintained by the first computer processor;
interrogating the NFC tag by a NFC interrogator connected to a mobile communication device, or image-capture the barcode by a barcode scanner or camera connected to the mobile communication device, wherein the mobile communication device being equipped with one or more processors and configured to communicate with first computer processing server;
acquiring the interrogated NFC tag ID or extracting the image-captured barcode data by the mobile communication device;
sending, by the mobile communication device, the acquired NFC tag ID or extracted barcode data and identification data of the mobile communication device to the first computer processor;
finding and retrieving, by the first computer processor, the discount coupon record using the received NFC tag ID or barcode data;
adding, by the first computer processor, the discount coupon record data to a user account uniquely associated with the mobile communication device, such that the discount coupon is used in payment transactions are performed under the user account.

10. The method of claim 9, wherein the barcode being Quick Response (QR) code.
